(19) United States
(12) Patent Application Publication
(10) Pub. No.: US 2004/0148497 A1
(43) Pub. Date: Jul. 29, 2004

(54) Method and apparatus for determining an early reifetch address of a mispredicted conditional branch instruction in an out of order multi-issue processor

(76) Inventors: Ali Vahidsafa, Palo Alto, CA (US); Robert Nuckolls, Sunnyvale, CA (US); Sorin Iacobovici, San Jose, CA (US); Rabin Sugumar, Sunnyvale, CA (US); Suresh Thirumalaiswamy, Santa Clara, CA (US); Chandra Mohan Reddy Thimmannagari, Fremont, CA (US)

Correspondence Address: OSHA & MAY L.L.P./SUN, 1221 MCKINNEY, SUITE 2800, HOUSTON, TX, 77010, US

(21) Appl. No.: 10/351,850

(22) Filed: Jan. 27, 2003

(51) Int. Cl. G06F 9/00

(52) U.S. Cl. 712/239

(57) ABSTRACT

A method for determining a reifetch address of a branch instruction in a set of instructions involves decoding the set of instructions, forwarding the set of instructions along with a value of a branch counter, updating the branch counter based on the set of instructions, and predicting a result of executing the branch instruction in the set of instructions. If mispredicted, a source address of the branch instruction is calculated. The calculating involves shifting the value of the branch counter dependent on a shift value to generate a shifted value of the branch counter, and adding a working copy of the program counter or next program counter and the shifted value of the branch counter to generate the source address which is in turn used to determine the reifetch address.

### BACKGROUND OF INVENTION

A typical computer system includes at least a microprocessor and some form of memory. The microprocessor has, among other components, arithmetic, logic, and control circuitry that interpret and execute instructions necessary for the operation and use of the computer system. FIG. 1 shows a typical computer system (10) having a microprocessor (12), memory (14), integrated circuits (IC) (16) that have various functionalities, and communication paths (18, 20), i.e., buses and wires, that are necessary for the transfer of data among the aforementioned components of the computer system (10).

An instruction executed by the typical computer system shown in FIG. 1, at the lowest level, is a series of ones and zeroes that describe physical operations. Assembly code is an abstraction of the series of ones and zeroes representing physical operations within the computer that allow humans to write instructions for the computer. Examples of instructions written in assembly code include ADD, SUB, MUL, DIV, BR, etc. The examples of instructions previously mentioned are typically combined as an assembly program (or generally, a program) to accomplish sophisticated computer operations.

Depending on the type of instruction being executed, storage areas or registers are specified that contain data or a address to location that contains data used in executing the instruction. Additional registers are used to facilitate the execution of instructions in a program, e.g., instruction registers, status registers, pipe stage registers, and a program counter. The instruction register contains the instruction that is currently being executed. Pipe stage registers store parts of an instruction being forwarded and/or executed. The status register records comparisons between registers, and the program counter (PC) contains an address of the next instruction to be executed by the program. A next program counter (nPC) is often used to store the next address for the PC (the next address may be an increment of four from the current address).

Instructions may change a flow of control in a program and in these cases, the program counter is significant. Examples of instructions that may change control flow include jumps, branches, procedure calls, and procedure returns. The destination address of an instruction that may change the flow of control in a program must be specified. For example, within a branch instruction, which is a conditional change of flow control, the destination address must be determined before the instruction following the branch instruction can be executed. A common way to specify a destination address of a branch instruction is to supply a displacement that is added to the program counter (PC). Control flow instructions of this sort are called “PC-relative.”

Because destination addresses are determined for branch instructions during execution, branch instructions tend to affect microprocessor performance as the pipeline cannot be filled or the instructions in the pipeline need to be flushed to execute other sets of instructions. Therefore, branch prediction methods are used to efficiently manage branch instructions. In particular, fetch units use branch prediction methods to determine whether a branch instruction should be predicted as ‘branching’ off to another instruction (taken) or as falling through to the next instruction in the program (untaken).

In one example of branch prediction methods, a branch history table (BHT) and a branch target cache (BTC) are used. The BHT stores entries, i.e., bits, to denote a branch instruction that was previously taken or untaken. Based on previous instances in which a branch instruction was encountered, a prediction is made regarding whether the current branch instruction should be taken or untaken. The BTC stores the destination addresses of several branches.

However, once the destination address is determined in the execution unit, if the branch instruction is found to be mispredicted, the original address (i.e., the source address) of the branch instruction must be determined so that the correct instruction stream after the branch instruction may be fetched. Typically, the source address is determined by forwarding and staging a copy of a value of the PC along with the branch instruction, i.e., the value of the PC is the source address of the branch instruction. Determining the source address of mispredicted branch instructions is potentially costly with respect to power and area consumption due to the forwarding and staging of the copy of the PC.

### SUMMARY OF INVENTION

In general, one aspect of the invention involves a method for determining a reifetch address of a mispredicted conditional branch instruction in a set of instructions. The method involves decoding the set of instructions, forwarding the set of instructions along with a value of a branch counter appended with each of the valid instructions in the set of instructions, and updating the branch counter based on the set of instructions. If mispredicted, the source address of the conditional branch instruction is calculated. The calculating involves shifting the value of the branch counter dependent on a shift value to generate a shifted value of the branch counter, and adding a working copy of the program counter or next program counter and the shifted value of the branch counter to generate the source address and in turn generate the reifetch address.

In general, one aspect of the invention involves an apparatus for determining a reifetch address of a mispredicted conditional branch instruction in a set of instructions. An apparatus involves a decode unit arranged to decode and forward the set of instructions along with a value of a branch counter appended with each valid instruction in the set of instructions, where the decode unit uses the branch counter, and a branch unit arranged to verify predictive actions of the branch instruction initiated by the fetch unit and if mispredicted, calculate the source address of the branch instruction, where the branch unit uses a working copy of a program counter or next program counter to determine the source address and in turn generate the reifetch address.

In general, one aspect of the invention involves a method for determining a reifetch address of a mispredicted conditional branch instruction in a set of instructions. The method involves step for decoding the set of instructions, step for forwarding the set of instructions along with a value of a branch counter appended with each valid instruction in the set of instructions, and step for updating the branch counter based on the set of instructions. If mispredicted, the source address of the branch instruction is calculated and in turn generate the reifetch address. The step for calculating the source address involves step for shifting the value of the branch counter dependent on a shift value, and step for adding a working copy of the program counter or next program counter, and the value.

In general, one aspect of the invention involves an apparatus for determining a reifetch address of a mispredicted conditional branch instruction in a set of instructions. The apparatus involves means for decoding and forwarding the set of instructions along with a value of a means for counting the number of valid instructions being forwarded appended with each valid instruction in the set of instructions, where the means for decoding and forwarding uses the means for counting the number of valid instructions being forwarded by the means for decoding and forwarding, and means for verifying predictive actions of the branch instruction initiated by a means for fetching the set of instructions and if mispredicted, means for calculating the source address of the branch instruction, and in turn the reifetch address.

Other aspects and advantages of the invention will be apparent from the following description and the appended claims.

### BRIEF DESCRIPTION OF DRAWINGS

FIG. 1 shows a typical computer system.

FIG. 2 shows a diagram of a microprocessor in accordance with an embodiment of the present invention.

FIG. 3 shows a diagram of an execution unit in a microprocessor in accordance with an embodiment of the present invention.

FIG. 4 shows a diagram of a decode unit in accordance with an embodiment of the present invention.

FIG. 5 shows a diagram of a branch unit in accordance with an embodiment of the present invention.

FIG. 6 shows a flow process for handling branch instructions in accordance with an embodiment of the present invention.

FIGS. 7A-7C show decision diagrams for updating the branch counter in accordance with an embodiment of the present invention.

FIGS. 8A and 8B show decision diagrams for forwarding a branch counter value with each respective instruction in a fetch group in accordance with an embodiment of the present invention.

FIGS. 9A-9D show decision diagrams for updating a branch program counter and a branch next program counter in a branch unit and for determining a reifetch address and a next reifetch address of a mispredicted conditional branch instruction in accordance with an embodiment of the present invention.

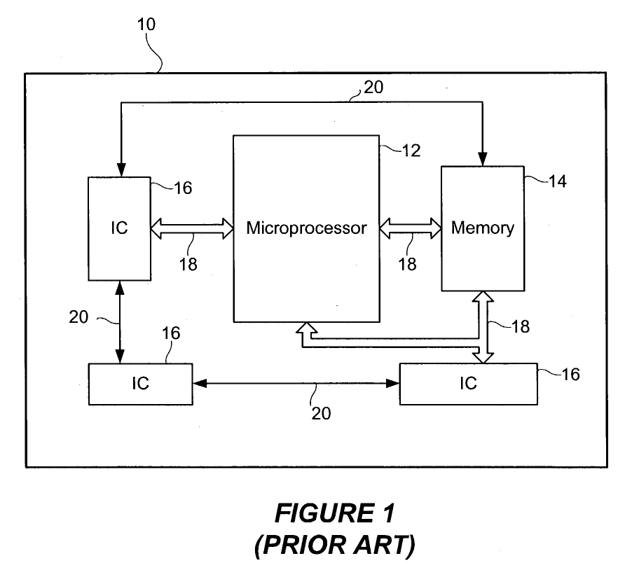

### DETAILED DESCRIPTION

Specific embodiments of the invention will now be described in detail with references to the accompanying figures. Like elements in various figures are denoted by like reference numerals throughout the figures for consistency.

In the following detailed description of the invention, numerous specific details are set forth in order to provide a more thorough understanding of the invention. However, it will be apparent to one of ordinary skill in the art that the invention may be practiced without these specific details. In other instances, well-known features have not be described in detail to avoid obscuring the invention.

Embodiments of the invention relate to a method for determining an instruction refetch (i.e., reifetch) address of a mispredicted conditional branch instruction. A branch counter (i.e., BC) is used in a decode unit. Copies of a program counter, for example, a branch program counter (i.e., BPC) and a branch next program counter (i.e., BnPC) are used in a branch unit. The BPC and BnPC along with the branch counter value allow branch instructions in a fetch group to be forwarded and properly executed without requiring a copy of the program counter to be forwarded with every instruction in order to determine the source address of the branch instruction.

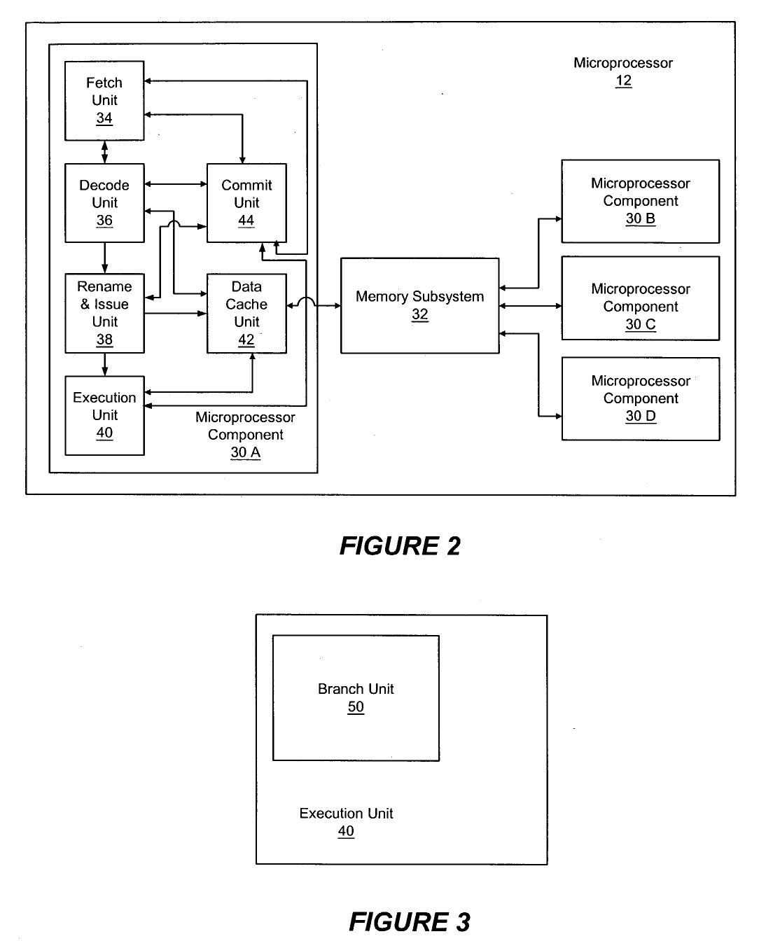

FIG. 2 shows a diagram of a microprocessor in accordance with an embodiment of the present invention. The microprocessor (12) includes four microprocessor components (30A-30D). The microprocessor (30A) is in communication with the microprocessor components (30B-30D) through a memory subsystem (32) that provides memory operations for data that is not available in a cache memory (not shown) of the microprocessor (12). Each microprocessor component includes a fetch unit (34), a decode unit (36), a rename and issue unit (38), an execution unit (40), a data cache unit (42), and a commit unit (44).

The fetch unit (34) fetches a set of instructions (i.e., a fetch group) in any given cycle and forwards the fetch group to the decode unit (36). The fetch unit is also responsible for predicting the direction and the target address of the conditional branch instruction and forwarding this information to the decode unit. The decode unit (36) decodes the instructions and forwards the instruction to the rename and issue unit (38), which, in turn, renames register fields along with updating appropriate rename tables. The issue queue (not shown) within the rename and issue unit (38) issues the instructions to the execution unit (40). The execution unit (40) executes the instructions and writes the results into a working register file (WRF) (not shown). When the instruction finishes execution without exceptions, a commit unit (44) commits the instructions and in some cases writes the value in the WRF (not shown) to an architectural register file (ARF) (not shown). A data cache unit (42) handles all of the load and stores associated with executing the instruction.

FIG. 3 shows a diagram of an execution unit in a microprocessor in accordance with an embodiment of the present invention. The execution unit (40) includes a branch unit (50) that handles branch instructions. The branch unit (50) handles branch execution, and branch verification (i.e., verifying whether the branch instruction was predicted correctly).

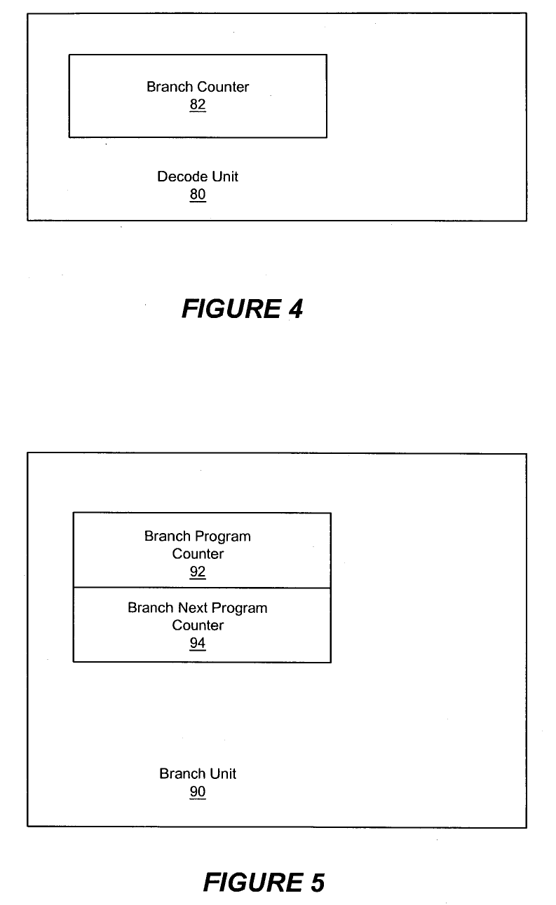

Instructions fetched by a fetch unit (34) as shown in FIG. 2 forward instructions to a decode unit (36). FIG. 4 shows a decode unit in accordance with an embodiment of the present invention. The decode unit (80) includes a branch counter (BC) (82). The BC (82), in one or more embodiments, is a counter that updates by incrementing or resetting a counter increment for every valid instruction forwarded down a pipeline. In one or more embodiments, BC is a ten-bit wide counter.

As shown in FIG. 2, the decode unit 80 via a rename and issue unit (i.e., RIU) (38) forwards instructions through the pipeline to the execution unit (40). If the instruction is a branch instruction, the instruction along with the associated branch counter value is forwarded to the branch unit (50) in FIG. 3 within the execution unit (40).

FIG. 5 shows a diagram of an exemplary branch unit in accordance with an embodiment of the present invention. The branch unit (90) includes a branch program counter (i.e., BPC) (92) and a branch next program counter (i.e., BnPC) (94). The BPC (92) and the BnPC (94) are updated in the event that a branch instruction is found to be taken or mispredicted.

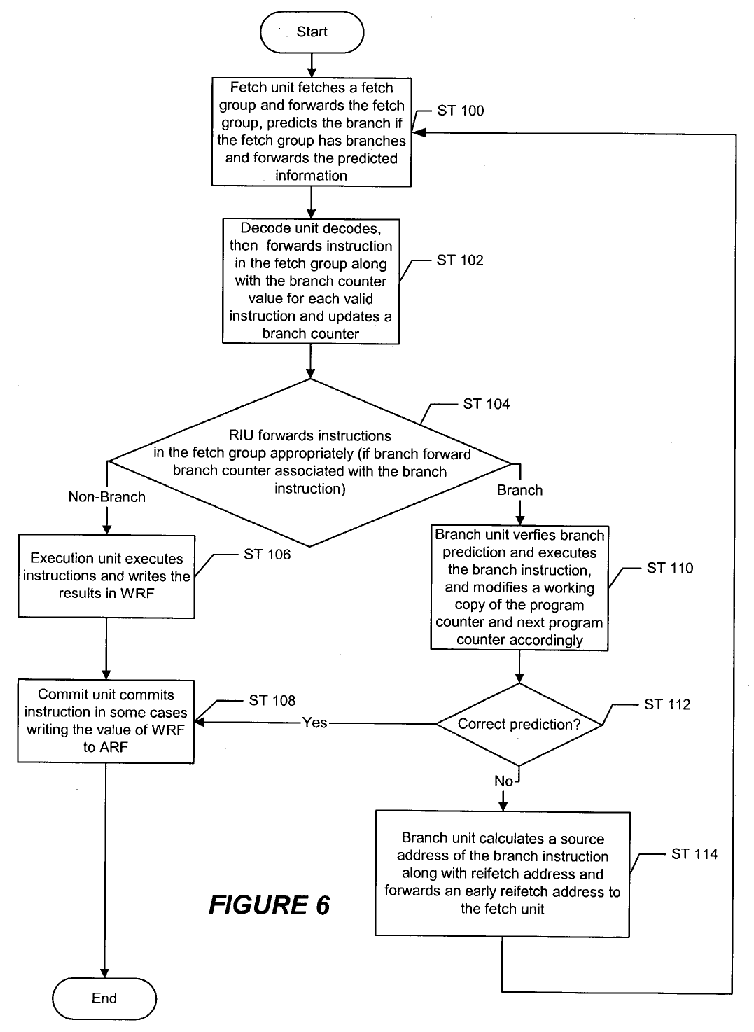

FIG. 6 shows an exemplary flow process for handling a branch instruction in accordance with an embodiment of the present invention. Initially, a fetch unit fetches a fetch group and forwards the fetch group to a decode unit that includes a branch counter (Step 100). Additionally, when the fetch unit fetches the instructions, if the instruction is a branch instruction, the fetch unit takes predictive action, i.e., forwards the branch instruction as taken or not taken to the decode unit.

In one or more embodiments, the fetch unit predicts a branch instruction as taken or untaken using a branch history table and predicts the target address of the branch instruction, in some cases, using a branch target cache. One skilled in the art will understand that a fetch unit may predict a branch instruction as taken or untaken in a variety of ways.

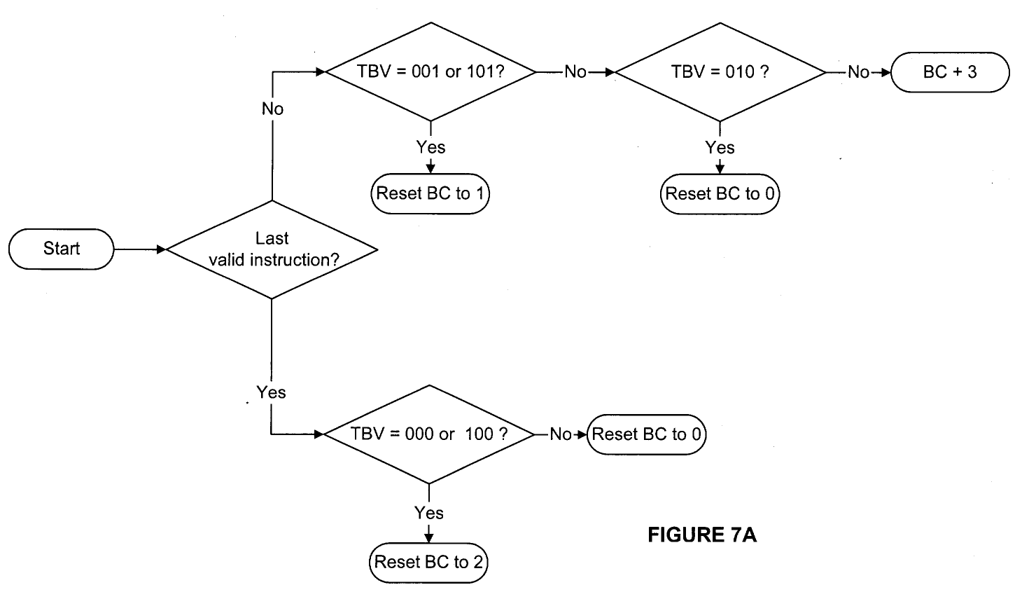

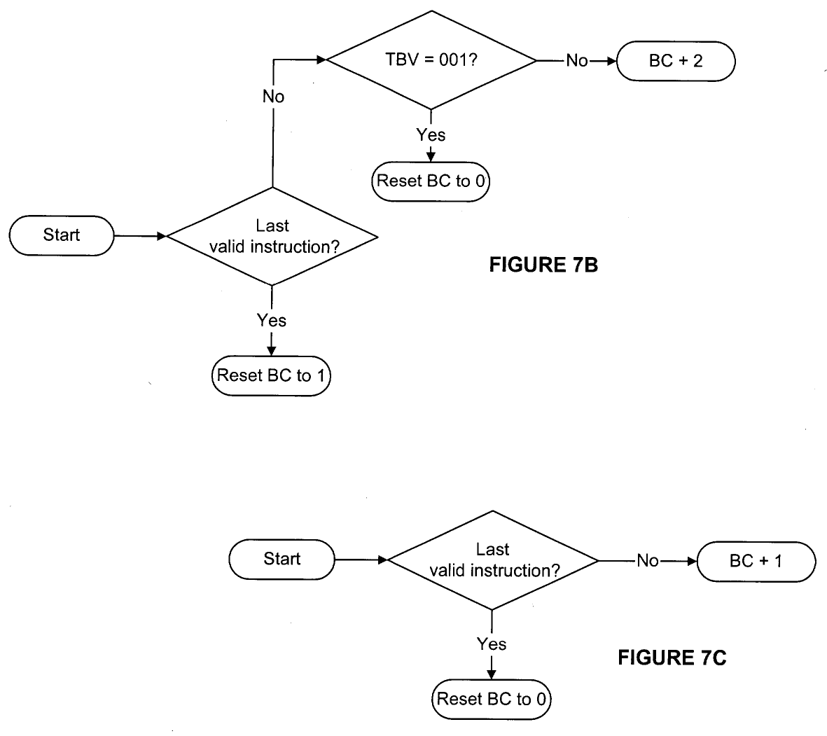

The BC in the decode unit is set to some initial value and updates according to the instructions in the fetch group. FIGS. 7A-7C show exemplary decision diagrams for updating the branch counter in accordance with an embodiment of the present invention.

One skilled in the art will understand that the decision diagrams to follow are not a listing of sequential steps, rather a series of conditions by which each instruction or fetch group is evaluated, such that a value of a branch counter, or reifetch address, etc. may be determined.

In particular FIG. 7A shows an exemplary decision diagram for updating the BC, if all instructions in the fetch group, e.g., all three instructions, are valid, i.e., the instructions are part of a set of instructions defined for a particular microprocessor, e.g., the microprocessor shown in FIG. 2. First, it is determined whether the last valid instruction in the previous fetch group was a conditional branch instruction that was predicted as taken. Also, it is determined whether any of the instructions in the current fetch group are branch instructions that are predicted as taken. In one embodiment, a taken branch vector (TBV) shows a number of predicted taken branches in a fetch group. For example, TBV=100 indicates that the youngest instruction in the fetch group is a branch instruction that is predicated as taken, whereas TBV=011 indicates the two oldest instructions in the fetch group are predicted as taken.

As shown in FIG. 7A, based on the last valid instruction in the previous fetch group and the TBV, the BC is either reset or incremented. For example, if the last valid instruction was a branch instruction predicted as taken and the TBV indicates a 000, i.e., none of the instructions in the fetch group are branch instructions predicted as taken, or 100, i.e., the youngest instruction in the fetch group is a branch instruction predicted as taken, then the BC is reset to 2.

FIG. 7B shows an exemplary decision diagram for updating the branch counter, if the two oldest instructions in the fetch group are valid. Similarly, the BC is reset or incremented based on the last valid instruction in the previous fetch group and the TBV. FIG. 7C shows an exemplary decision diagram for updating the BC, if only the oldest instruction in the fetch group is valid. The BC, in this instance, is solely based on the last valid instruction of the previous fetch group. If none of the instructions in the fetch group are valid, the BC is not updated.

Further, in one embodiment, if the fetch unit receives a non-sequential access from the commit unit or branch unit, the BC is reset to hexadecimal value FFF. For example, if a branch instruction is mispredicted, a non-sequential access resulting in resetting the BC to FFF. In the case of BC overflow condition, the decode unit stalls on a fetch group following the fetch group which resulted in an overflow and waits for the commit unit to resolve this. The commit unit resolves this by committing all instructions in the pipe (assuming none of the instructions resulted in an exception) and then issuing a “reifetch” and a “clear pipe” control signal.

Referring to FIG. 6, the decode unit decodes and forwards a branch counter value appended with each of the instructions to a rename and issue unit (Step 102).

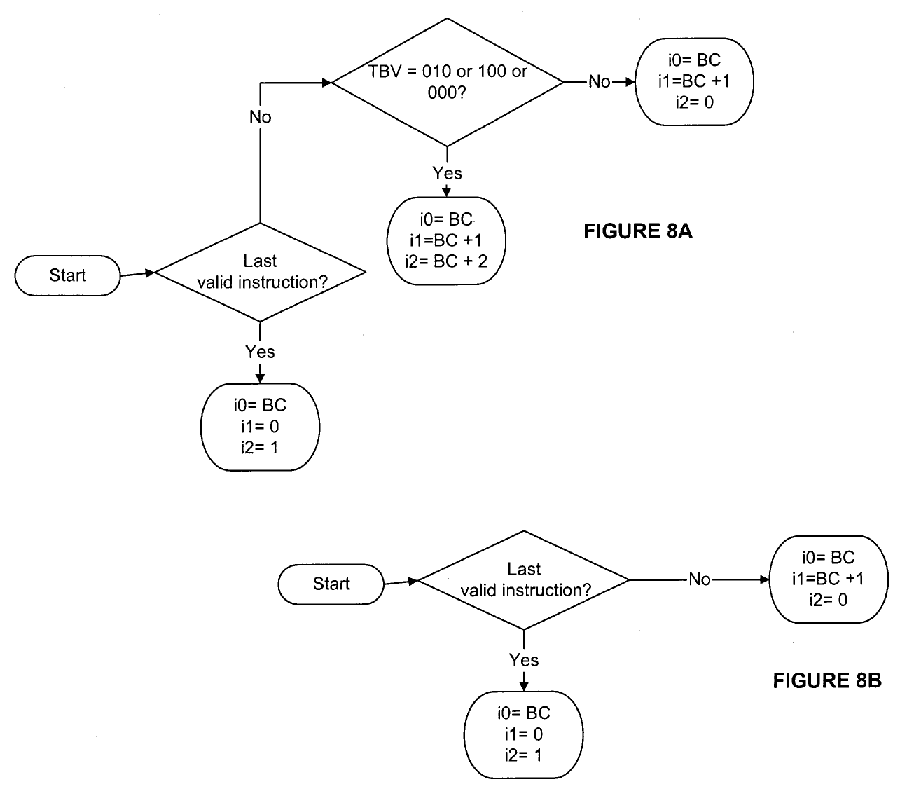

FIGS. 8A and 8B show decision diagrams for forwarding a branch counter value with each respective instruction in a fetch group in accordance with one embodiment of the present invention. In particular, FIG. 8A shows a decision diagram for forwarding a branch counter value with each respective instruction in a fetch group if all the instructions in the fetch group are valid. Based on the last valid instruction of the previous fetch group and the TBV, the first, second, and third, instructions of the fetch group (i0, i1, i2) are forwarded along with particular branch counter values derived from the BC to the rename and issue unit. For example, if the last valid instruction in the previous fetch group was a branch instruction predicted as taken, then the first instruction is forwarded with the current BC value, the second instruction is forwarded with a 0, and the third instruction is forwarded with a 1.

FIG. 8B shows an exemplary decision diagram for forwarding a branch counter value with each respective instruction in the fetch group if the two oldest instructions are valid. If, however, only the oldest instruction is valid, the first instruction is forwarded with the branch counter value and the second and third instructions are forwarded with a “don't care” value. Meaning, this value that does not affect the execution of the fetch group as it is forwarded along with the second and third instructions to the rename and issue unit.

In FIG. 6, the rename and issue unit (or RIU) properly forwards the instructions to either an execution unit, or specifically, a branch unit within the execution unit (Step 104). If the instruction is a non-branch instruction, the instructions are forwarded to the execution unit (Step 106). In the execution unit, the non-branch instructions are executed and the results are written to a WRF. Once the instruction has completed execution without exception, the commit unit commits instructions and, in some cases, writes the value in the WRF to the ARF (Step 108).

If, however, the instruction is a branch instruction, the instructions are forwarded to the branch unit of the execution unit (Step 104). The branch unit verifies whether the branch instruction was correctly predicted and executes the branch instruction accordingly (Step 110).

If the branch prediction is correct (Step 112), then the branch unit forwards a completion report to the commit unit which, in turn, commits the branch instruction once the branch instruction has completed execution without exception (Step 108).

If the branch prediction is incorrect, the branch unit forwards the reifetch address (i.e., reif-PC) and next reifetch address (i.e., reif-nPC) to the fetch unit (Step 114). In order to calculate the reif-PC, a source address of the branch instruction is determined by first obtaining the branch counter value. The branch counter value is shifted to the left by a shift value to generate a correction value. The sum of the correction value and the current value of the working copy of the program counter (i.e., BPC) or the next program counter(i.e., BnPC) is the source address (i.e., PC) of the branch instruction.

For example, consider a value of the branch counter value is at two:

| Decimal value | Binary value |
|---|---|
| 2 | 0000000010 |

The branch counter value, e.g., two, is shifted to the left by the shift value, e.g., two, resulting in the correction value as follows:

| Decimal value | Binary value |
|---|---|
| 8 | 0000001000 |

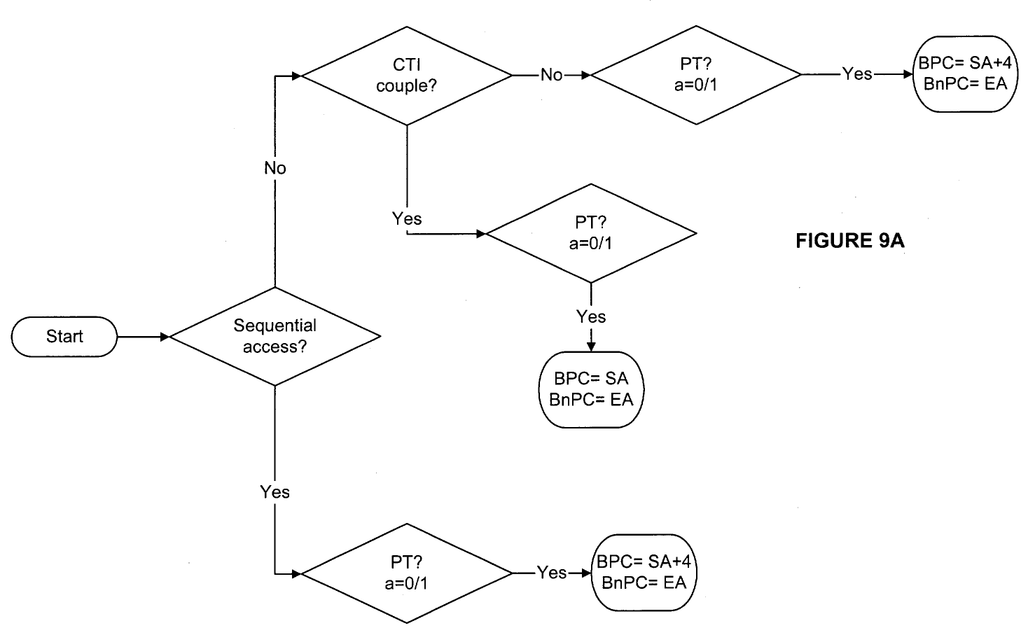

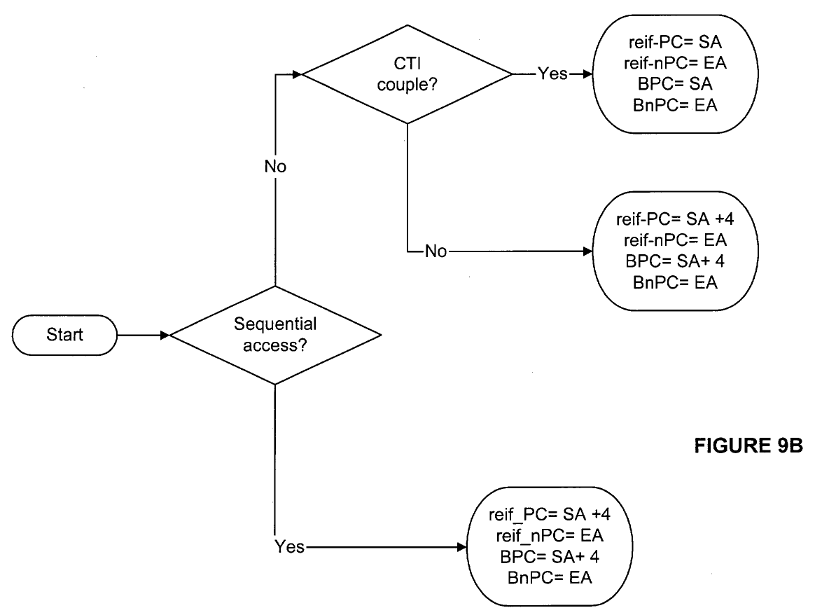

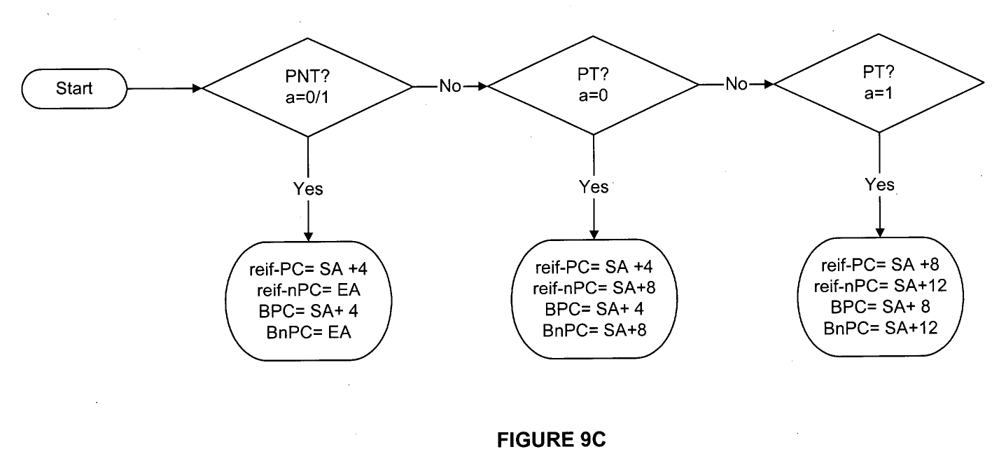

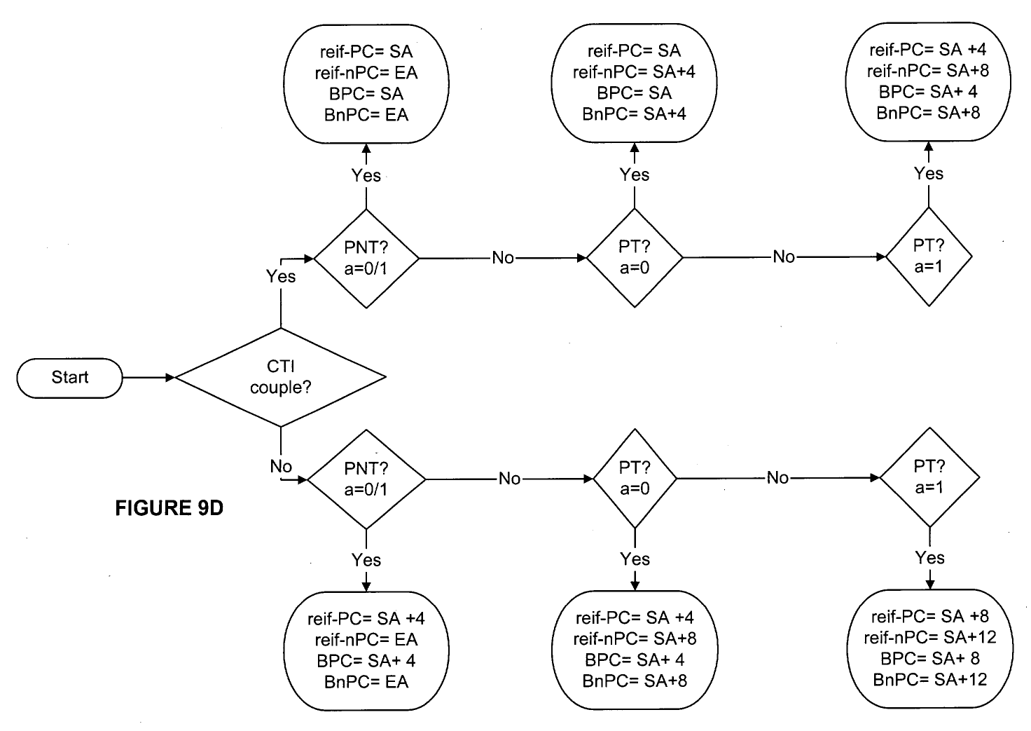

The correction value (shifted value of the branch counter), e.g., 8, is added to the current value of BPC or BnPC. Accordingly, the source address is used in FIG. 9B-9D to determine the reifetch address (reif-PC) of the mispredicted conditional branch instruction.

FIGS. 9A-9D show exemplary decision diagrams for updating a BPC, a BnPC in a branch unit, and for determining a reif-PC and a reif-nPC of a conditional branch instruction in accordance with one embodiment of the present invention.

In particular, FIG. 9A shows an exemplary decision diagram for updating the BPC and BnPC in a branch unit if the conditional branch instruction is predicted correctly. Because the branch instruction is predicted correctly, a reif-PC and a reif-nPC are not determined. Dependent on if a most recent access to the fetch unit made by the commit unit or branch unit was sequential, if the conditional branch instruction is part of a control transfer instruction (CTI) couple, and if the branch instruction is predicted as taken (PT) or not taken (PNT), the BPC and BnPC are updated in accordance with the decision diagram. In addition to considering if the branch instruction is PT or PNT, an annul bit (i.e., a) also determines if and how the BPC and BnPC are updated. In one or more embodiments, if the annul bit is set to logic 1, the instruction in the delay slot is nullified for certain branch conditions.

On the other hand, a conditional branch instruction can be mispredicted with respect to direction, i.e., PT or PNT, or with respect to a target address. If the conditional branch instruction is mispredicted, a reif-PC and a reif-nPC are determined in addition to updating the BPC and BnPC as shown in FIGS. 9B-9D.

FIG. 9B shows an exemplary decision diagram for updating the BPC and BnPC and for determining a reif-PC and a reif-nPC if the conditional branch instruction is mispredicted with respect to the target address. On the other hand, FIGS. 9C and 9D show decision diagram for updating BPC, BnPC, reif-PC, and reif-nPC if the conditional branch instruction was mispredicted with respect to the direction. In particular, FIG. 9C shows that updating the BPC, reif-PC, etc., depends on whether the last fetch initiated by the commit unit or the branch unit was sequential. FIG. 9D shows that updating the BPC, reif-PC, etc., depends on whether the last fetch initiated by the commit unit or the branch unit was non-sequential.

In one or more embodiments, if the last fetch initiated by the commit unit or branch unit was sequential, the source address is calculated by summing a BPC and a correction value. Otherwise, the source address is calculated by summing a BnPC and a correction value.

Table 1 shows the results of determining reifetch addresses of a mispredicted conditional branch instruction in a set of instructions in accordance with an embodiment of the present invention. Lines 1-16 indicate each instruction in the set of instructions. There are three branch instructions: lines 4, 9, and 13. The remaining lines contain instructions that are considered non-branch instructions. Each instruction is indicated by a line number along with the counter value associated, also a branch unit result, a branch program counter (BPC), a branch next program counter (BnPC), and reifetch address. For example, in line 1, an instruction is executed, the counter value appended to the instruction is zero, the branch unit has not been invoked (null value), the copy of the BPC and BnPC maintain the initial values (zero and zero plus 4), and there is no reifetch address.

In line 4, the first branch instruction is encountered by the decode unit. Because the three previous instructions were valid, non-branch instructions, the branch counter holds a value of 3. Using a prediction history table, the branch instruction in line 4, is predicted as not taken (PNT) by fetch unit. Accordingly, the BPC and the BnPC are not updated, and the branch unit verifies correct prediction. The branch instruction along with the predicted information and branch counter value is forwarded to rename and issue unit. The branch counter in the decode unit is incremented and the next instruction is executed.

In line 9, the second branch instruction is encountered by the decode unit. The previous four instructions were non-branch instructions. Accordingly, the branch counter in the decode unit has incremented eight times, resulting in the value 8. Using a prediction history table, the branch instruction in line 9 is predicted as taken by the fetch unit.

In the present example, a branch target cache in fetch unit is used to assign a destination address of 50 and, at this point, the branch unit determines if the branch instruction was correctly predicted both in direction and target address, and the copy of the BPC and the BnPC are updated with the values of, the program counter of the delay slot instruction ((BPC+branch value<<2)+4) i.e., 36) and target address of the branch instruction (i.e., 50). The branch unit verifies that branch prediction is correct both in direction and target address. After executing a branch delay (typical of most branch instructions), in line 10, the counter equals 9 and in line 11, the counter is reset to 0.

TABLE 1
Determining Source Address of Branch Instruction

| | | Counter | | | |
|---|---|---|---|---|---|
| Line | | in decode | Branch | BPC/ | Reifetch |
| No. | Instruction | unit | unit result | BnPC | Address |
| 1 | ADD1 | 0/1 | — | 0/4 | — |
| 2 | SUB1 | 1/2 | — | 0/4 | — |
| 3 | MUL1 | 2/3 | — | 0/4 | — |
| 4 | BR, PNT A = 0 | 3/4 | correctly | 0/4 | — |
| | | | predicted | | |
| 5 | DIV1 | 4/5 | — | 0/4 | — |
| 6 | ADD2 | 5/6 | — | 0/4 | — |
| 7 | SUB2 | 6/7 | — | 0/4 | — |
| 8 | MUL2 | 7/8 | — | 0/4 | — |
| 9 | BR, PT, A = 0/1 | 8/9 | correctly | 36/50 | — |
| | | | predicted | | |
| 10 | DIV2 | 9/0 | — | 36/50 | — |
| 11 | ADD3 | 0/1 | — | 36/50 | — |
| 12 | SUB3 | 1/2 | — | 36/50 | — |
| 13 | BR, PNT, A = 1 | 2/3 | incorrectly | 62/80 | reif-PC = 62 |
| | | | predicted | | reif-nPC = 80 |
| 14 | DIV3 | FFF/0 | — | 62/80 | — |
| 15 | ADD4 | 0/1 | — | 62/80 | — |
| 16 | SUB4 | 1/2 | — | 62/80 | — |

In line 13, the third branch instruction is encountered by the decode unit. The two previous instructions (lines 11 and 12) were non-branch instructions. Accordingly, the branch counter in the decode unit has incremented twice, resulting in a value of 2. Using a prediction history table, the branch instruction in line 13, is predicted as not taken by the fetch unit. The branch unit verifies the branch prediction, however the branch instruction was mispredicted. Therefore, the reifetch address of the branch instruction should be determined to maintain program correctness.

The reifetch address is determined by following the decision diagrams shown in FIGS. 9A-9D. BPC updates with the reif-PC (i.e., 62) and BnPC updates with the reif-nPC (i.e., 80).

In line 14, the counter is initialized to “FFF,” because branch unit issues a non-sequential access. The branch unit result is null as the branch unit is not invoked. The branch program counter (i.e., BPC) and the branch next program counter (i.e., BnPC) in the branch unit are not updated.

Advantages of the present invention may include one or more of the following. In one or more embodiments, the performance of a pipeline may be increased by providing an early reifetch in the case of branch mispredict. In one or more embodiments, the area and power consumption may be decreased by using the branch counter value appended with the branch instruction to determine the reifetch address in the case of a branch mispredict.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for determining a reifetch address of a branch instruction in a set of instructions, comprising:
decoding the set of instructions;
forwarding the set of instructions along with a value of a branch counter appended with each valid instruction in the set of instructions;
updating the branch counter based on the set of instructions; and
predicting a result of executing the branch instruction in the set of instructions;
if mispredicted, calculating a source address of the branch instruction, wherein the calculating comprises:
shifting the value of the branch counter dependent on a shift value to generate a shifted value of the branch counter;
adding a working copy of the program counter or next program counter and the shifted value of the branch counter to generate the source address;
determining the reifetch address from the source address.

2. The method of claim 1, wherein the predicting comprises referencing a branch history table and a branch target cache.

3. The method of claim 1, wherein the updating the branch counter comprises incrementing the branch counter by a counter increment in response to the forwarding of valid instructions in the set of instructions, a last valid instruction in a previous fetch group, and a taken branch vector.

4. The method of claim 1, wherein the updating the branch counter comprises resetting the branch counter.

5. The method of claim 1, wherein the forwarding the set of instructions is dependent on a taken branch vector and a last valid instruction in a previous fetch group.

6. The method of claim 1, wherein the determining the reifetch address is dependent on the source address, whether the branch instruction is part of a control transfer instruction couple, the predicting the result of executing the branch instruction, and whether a last access to a fetch unit made by a commit unit or a branch unit was sequential.

7. The method of claim 1, further comprising:
updating the working copy of the program counter, wherein the working updating the copy of the program counter is dependent on the source address, whether the branch instruction is part of a control transfer instruction couple, the predicting the result of executing the branch instruction, and whether a last access to a fetch unit made by a commit unit or a branch unit was sequential.

8. The method for determining a reifetch address of a branch instruction in a set of instructions, comprising:
step for decoding the set of instructions;
step for forwarding the set of instructions along with a value of a branch counter appended with each valid instruction in the set of instructions;
step for updating the branch counter based on the set of instructions;
step for predicting a result of executing the branch instruction in the set of instructions;
if mispredicted, step for calculating a source address of the branch instruction, wherein step for calculating comprises:
step for shifting the value of the branch counter dependent on a shift value to generate a shifted value of the branch counter; and
step for adding a working copy of the program counter or next program counter and the shifted value of the branch counter to generate the source address; and
step for determining the reifetch address from the source address.

9. The method of claim 8, wherein the step for predicting comprises a step for referencing a branch history table and a branch target cache.

10. The method of claim 8, wherein the step for updating the counter comprises a step for incrementing the branch counter by a counter increment in response to the step for forward valid instructions in the set of instructions, a last valid instruction in a previous fetch group, and a taken branch vector.

11. The method of claim 8, wherein the step for updating the counter comprises a step for resetting the branch counter.

12. The method of claim 8, wherein the step for forwarding the set of instructions is dependent on a taken branch vector and a last valid instruction in a previous fetch group.

13. The method of claim 8, wherein the step for determining the reifetch address is dependent on the source address, whether the branch instruction is part of a control transfer instruction couple, the predicting the result of executing the branch instruction, and whether a last access to a fetch unit made by a commit unit or a branch unit was sequential.

14. The method of claim 8, further comprising:
step for updating the working copy of the program counter, wherein the step for updating the working copy of the program counter is dependent on the source address, whether the branch instruction is part of a control transfer instruction couple, the predicting the result of executing the branch instruction, and whether a last access to a fetch unit made by a commit unit or a branch unit was sequential.

15. An apparatus for determining a reifetch address of a branch instruction in a set of instructions, comprising:
a decode unit arranged to decode and forward the set of instructions along with a value of a branch counter appended with each valid instruction in the set of instructions, wherein the decode unit comprises the branch counter; and
a branch unit arranged to verify predictive actions of the branch instruction initiated by a fetch unit and if mispredicted, calculate a source address of the branch instruction, wherein the branch unit comprises a working copy of a program counter or next program counter to determine the reifetch address.

16. The apparatus of claim 15, wherein the copy of the program counter is arranged to be updated in response to the source address, whether the branch instruction is part of a control transfer instruction couple, the result of predictive actions initated by the fetch unit, and whether a last access to a fetch unit made by a commit unit or a branch unit was sequential.

17. The apparatus of claim 15, wherein the branch counter is arranged to be updated based on the set of instructions.

18. An apparatus for determining a reifetch address of a branch instruction in a set instructions, comprising:
means for decoding and forwarding the set of instructions along with a value of a means for counting the number of instruction being forwarded appended with each valid instruction in the set of instructions, wherein the means for decoding and forwarding comprises a means for counting the number of instructions being forwarded; and
means for calculating and verifying predictive actions of the branch instruction initiated by means for fetching and if mispredicted, calculating a source address of the branch instruction, wherein the means for calculating and verifying comprises a copy of a means for storing the current address being executed to determine the reifetch address.

19. The apparatus of claim 18, further comprising:
means for storing a value of the next address to be executed.
